(19) United States
(12) Patent Application Publication
(10) Pub. No.: US 2011/0040605 A1
(43) Pub. Date: Feb. 17, 2011

(54) ELECTRONIC VOTING SYSTEM

(76) Inventor: Geoffrey Prentix Evertz, Brooklyn, NY (US)

Correspondence Address: DWAYNE L. BENTLEY, ESQ.;DL BENTLEY LAW GROUP PLLC, Suite 500, 188 Montague Street, Brooklyn, NY, 11201, US

(21) Appl. No.: 12/498,854

(22) Filed: Aug. 17, 2009

(51) Int. Cl. G07C 13/00; H04L 9/32; G06F 15/16

(52) U.S. Cl. 705/12; 726/5

(57) ABSTRACT

A system for electronic voting is provided. A state primary server is configured to provide voting information of at least one voter through a private Intranet. A poll worker computer station is configured to receive the voting information of the at least one voter through the private Intranet. A biometric device is connected to the poll worker computer station, where the biometric device is configured to receive biometric information from a poll worker, where the biometric device validates that the poll worker can utilize the poll worker computer station. The poll worker computer station is configured to compare the voting information of the at least one voter with voter biometric information of at least one current voter to determine if the voter biometric information of the at least one current voter is equivalent to the voting information of the at least one voter; if the voting information of the at least one voter is equivalent to the voter biometric information of at least one current voter then the at least one voter can cast an electronic vote at least one voting booth of a plurality of voting booths, wherein the at least one voting booth is configured to transmit the electronic vote to the poll worker computer station or the local district server.

### FIELD OF THE INVENTION

The present invention relates to a system and method for electronic voting.

### BACKGROUND OF THE INVENTION

Since the inception of this country a voting system has been utilized in order to count ballots to elect various public officials, such as a councilman, mayor, senator, representative, Vice President and a President. The election process is a fundamental part of a democratic system, where the citizens of a country, such as the United States of America, France, England, Spain, South Africa, India and the other democratic nations around the world elect their representatives.

Typically, mechanical or electrical voting systems are utilized to allow citizens to vote on paper ballots for their representatives. These mechanical and electronic voting systems that allow physical alterations of the ballots are sometimes prone to problematic handling by the voters. This improper handling caused erroneous votes occur. Also, these erroneous votes caused frustration to the voters that inhibited them from voting.

There have been several patents that attempted to fix the erroneous voting systems. The first patent is U.S. Pat. No. 6,769,613 that describes an auto-verifying voting system. This patent provides the voter with the opportunity and responsibility to verify that the ballot with which he or she votes shows the votes as he or she intended. The next patent is U.S. Pat. No. 6,824,053 that is an electronic voting system that includes at least one voter interface unit associated with the network. The voter interface unit is able to identify a voter using a disability related communication device coupled to the network. The voter interface unit is able to identify a voter using a disability related communication device coupled to the network. Another patent is U.S. Pat. No. 6,873,966 that is a secure election system that provides a downloadable ballot viewer object for the casting of ballots. The ballot viewer authenticates the user, permits user interaction in the casting of ballots, seals the cast ballot image by encryption and transmits the cast ballot

However, none of the aforementioned voting system provide a separate system to authenticate and control the utilization of a voting system on a local, national and international level. Each of the aforementioned systems enables the user to verify his or her ballot, but doesn't provide an independent system to authenticate and control the voting system on a local, national and international level. This independent system will be less prone to voting error so the voters will not be inhibited from voting leading a robust voting system.

Therefore, there is a need for a separate voting system that is able to authenticate and control the utilization of a voting system on a local, national and international level.

### SUMMARY OF THE INVENTION

The present invention has been accomplished in view of the above-mentioned technical background, and it is an object of the present invention to provide a system and method for electronic voting.

In a preferred embodiment of the invention, a system for electronic voting is provided. A state primary server is configured to provide voting information of at least one voter through a private Intranet. A poll worker computer station is configured to receive the voting information of the at least one voter through the private Intranet. A biometric device is connected to the poll worker computer station, where the biometric device is configured to receive biometric information from a poll worker, where the biometric device validates that the poll worker can utilize the poll worker computer station. The poll worker computer station is configured to compare the voting information of the at least one voter with voter biometric information of at least one current voter to determine if the voter biometric information of the at least one current voter is equivalent to the voting information of the at least one voter; if the voting information of the at least one voter is equivalent to the voter biometric information of the at least one current voter then the at least one voter can cast an electronic vote in at least one voting booth station of a plurality of voting booth stations, wherein the at least one voting booth stations is configured to transmit the electronic vote to the poll worker computer station or the local district server.

In another preferred embodiment of the invention, a method for utilizing an electronic voting system is disclosed. Voting information of at least one voter is received through a private Intranet. Biometric information from a poll worker is received. The biometric information is validated that the poll worker can work at the poll worker computer station. The voting information of the at least one voter is compared with voter biometric information of the at least one current voter to determine if the voter biometric information of the at least one current voter is equivalent to the voting information of the at least one voter. An electronic vote is cast if the voting information of the at least one voter is equivalent to the voter biometric information of the at least one current voter.

### BRIEF DESCRIPTION OF THE DRAWINGS

These and other advantages of the present invention will become more apparent as the following description is read in conjunction with the accompanying drawings, wherein:

FIG.1 is a block diagram of a worldwide electronic voting system in accordance with the invention;

FIG. 2 is a block diagram of a national electronic voting system in accordance with the invention;

FIG. 3 is a block diagram of local electronic voting system in accordance with the invention;

FIG. 4 is a schematic of a poll worker computer station in accordance with the invention;

FIG. 5 is a flow-chart of the operation of the local electronic voting system of FIG. 3 in accordance with the invention;

FIG. 6 is a flow-chart of the operation of the national electronic voting system of FIG. 2 in accordance with the invention; and

FIG. 7 shows a screenshot of a graphical user interface of the worldwide electronic voting system of FIG. 1 in accordance with the invention;

FIG. 8 shows a screenshot of a graphical user interface of the district link of state servers of FIG. 2 in the U.S. in accordance with the invention;

FIG. 9 shows a screenshot of a graphical user interface of the folders of a New York district of FIG. 3 in accordance with the invention;

FIG. 10 shows a screenshot of a graphical user interface of a biometric scan in progress of FIG. 3 in accordance with the invention;

FIG. 11 shows a screenshot of a graphical user interface of several voting booths utilized by a poll worker computer station of FIG. 3 in accordance with the invention;

FIG. 12 shows a screenshot of a graphical user interface of a total vote count at each of several voting booths utilized by a poll worker computer station of FIG. 3 in accordance with the invention; and

FIG. 13 shows a graphical user interface of the general/local election results of FIG. 3 in accordance with the invention.

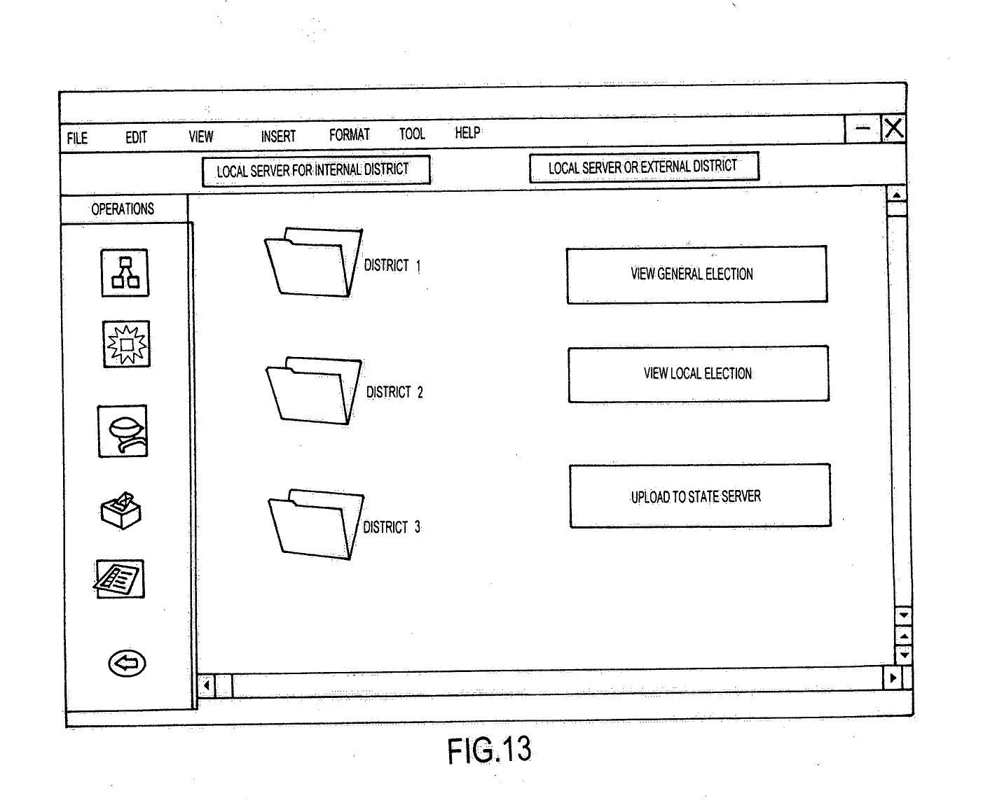

### DETAILED DESCRIPTION OF THE INVENTION

The presently preferred embodiments of the invention are described with reference to the drawings, where like components are identified with the same numerals. The descriptions of the preferred embodiments are exemplary and are not intended to limit the scope of the invention.

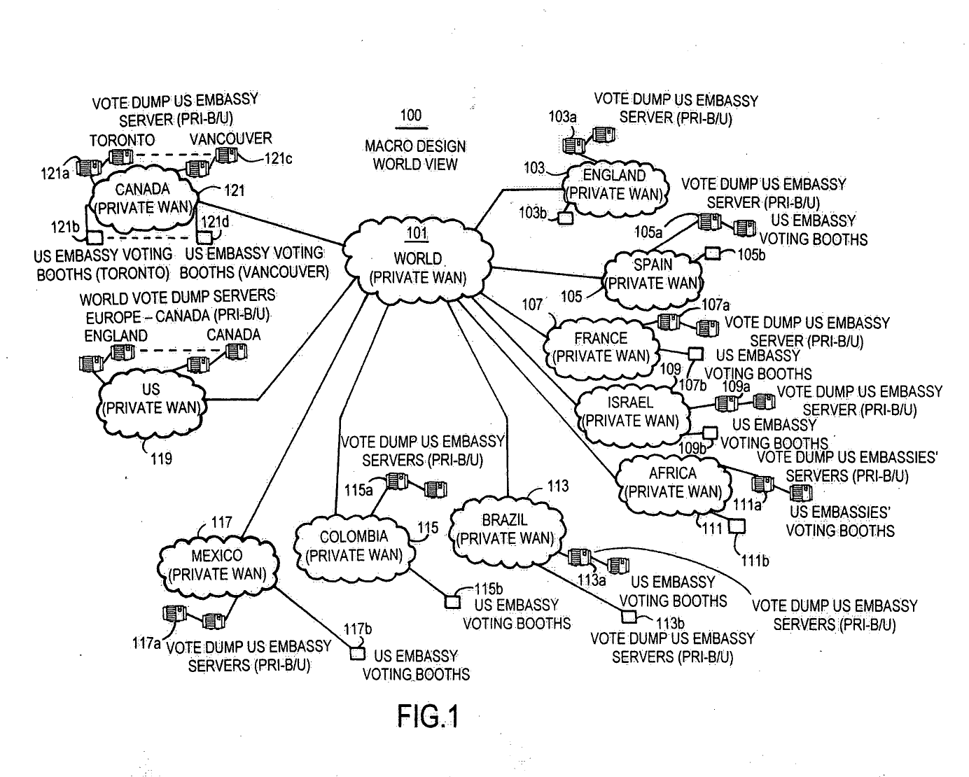

FIG. 1 is a block diagram of a worldwide electronic voting system in accordance with the invention. The world wide electronic voting system 100 includes: a typical private worldwide wide area network (WAN) 101 connected to, a private United Kingdom WAN 103, a private Spain WAN 105, a private France WAN 107, a private Israeli WAN 109, a private Africa WAN 111, a private Brazil WAN 113, a private Colombia WAN 115, a private Mexico WAN 117, a private US WAN 119 and a private Canada WAN 121. The wide area network (WAN) may also be a local access network (LAN), a wireless local network, a universal service bus (USB), an Ethernet link, a fiber-optic or the like.

Each of the aforementioned WANs is connected to each other by the World private WAN 101. WAN 101 acts as a typical wired area network communication system that is connected to England WAN 103, Spain WAN 105, France WAN 107, Israeli WAN 109, African WAN 111, Brazil WAN 113, Colombia WAN 115, Mexico WAN 117, US WAN 119 and the Canada WAN 121.

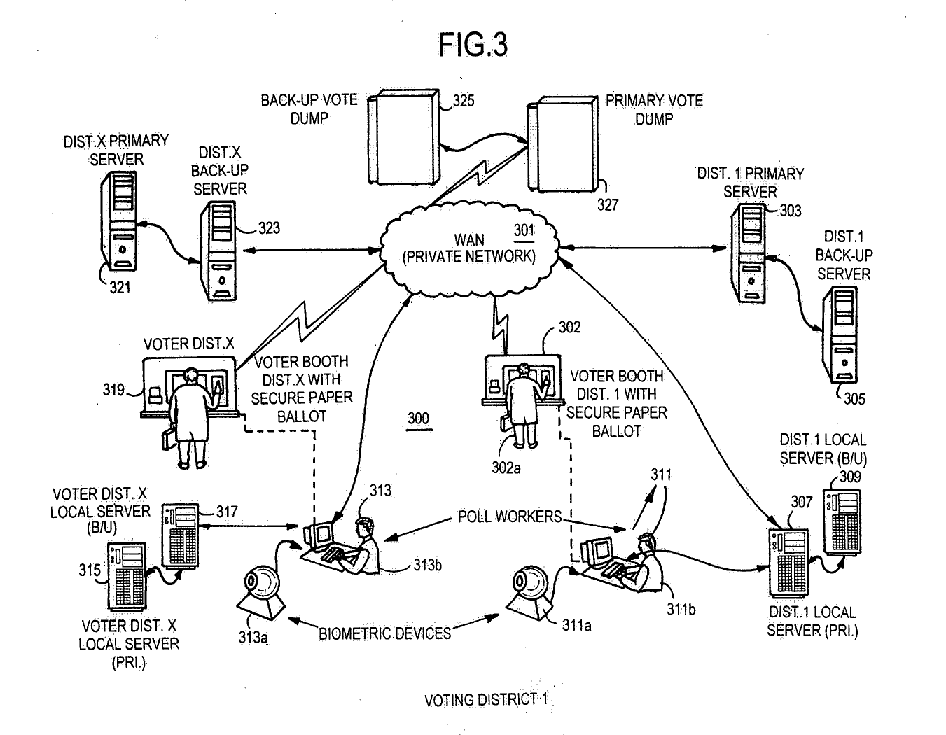

England WAN 103 includes a vote dump 103a and an embassy voting booth 103b connected to a local voting district with a poll worker computer station as shown in FIG. 3. The vote dump is a database or repository where all electronic ballots are stored, which include the following voter information: party affiliation, race, gender, election district, district assembly, congressional district, council district, civil court district, citizenship and age of the voter.

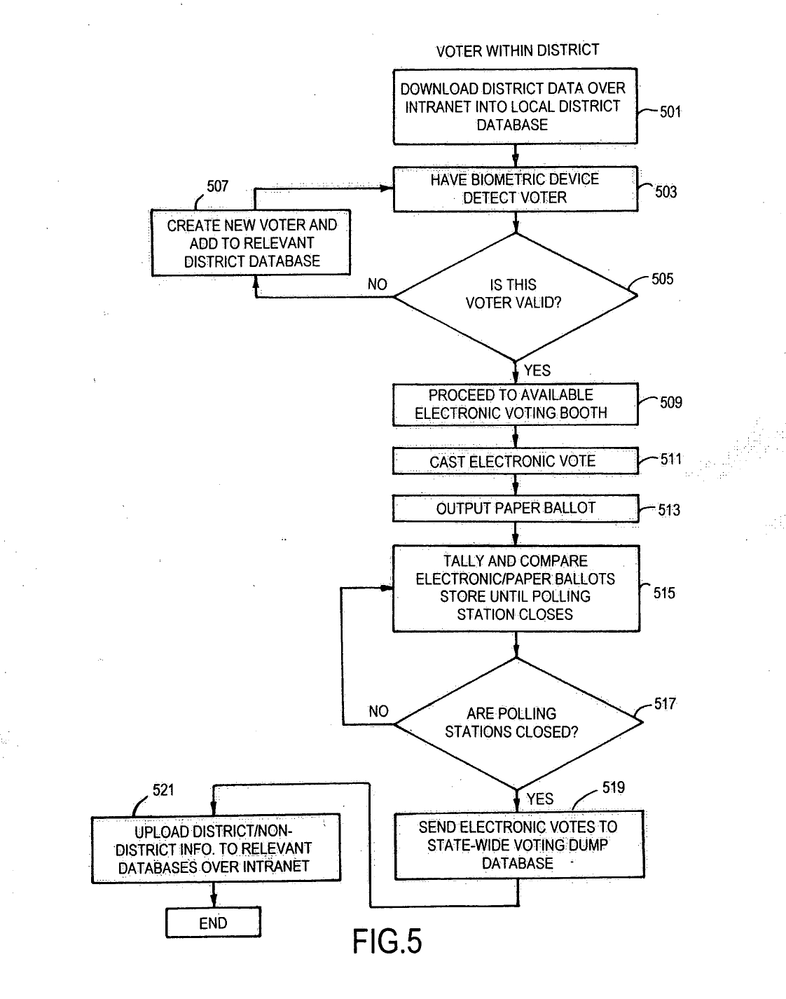

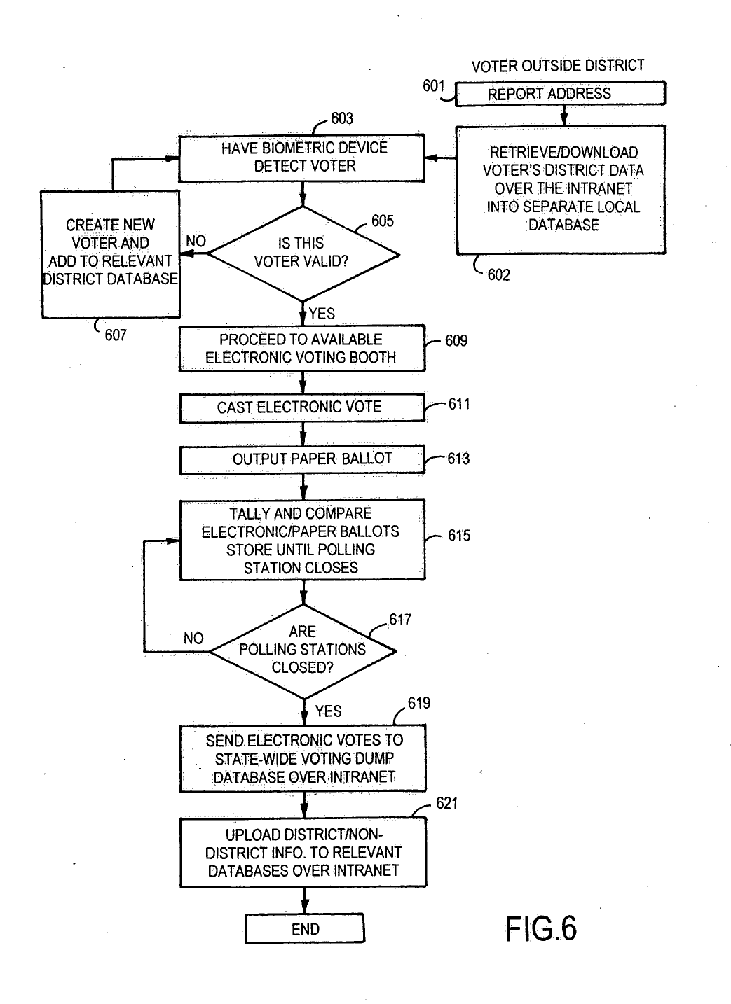

Spain WAN 105 includes a vote dump 105a and an embassy voting booth 105b connected to a local voting district with a poll worker computer station as shown in FIG. 3. France WAN 107 includes a vote dump 107a and an embassy voting booth 107b connected to a local voting district with a poll worker computer station as shown in FIG. 3. Israel WAN 109 includes a vote dump 109a and an embassy voting booth 109b connected to a local voting district with a poll worker computer station as shown in FIG. 3. Africa WAN 111 includes a vote dump 111a and an embassy voting booth 111b connected to a local voting district with a poll worker computer station as shown in FIG. 3. Brazil WAN 113 includes a vote dump 113a and an embassy voting booth 113b connected to a local voting district with a poll worker computer station as shown in FIG. 3. Colombia WAN 115 includes a vote dump 115a and an embassy voting booth 115b connected to a local voting district with a poll worker computer station as shown in FIG. 3. Mexico WAN 117 includes a vote dump 117a and an embassy voting booth 117b connected to a local voting district with a poll worker computer station as shown in FIG. 3. US WAN 119 includes a vote dump 119a and another vote dump 119b connected to a local voting district with a poll worker computer station as shown in FIG. 3. Canada WAN 121 includes a Toronto vote dump 121a and a Toronto embassy voting booth 121b connected to a local voting district with a poll worker computer station as shown in FIG. 3. Also, Canada WAN 121 includes a Vancouver vote dump 121c and a Vancouver embassy voting booth 121d. Each of the aforementioned countries or any known countries can have one or more local voting districts connected to their private WANs depending upon their needs, such as the cost of having one or more voting districts. The local voting districts will operate similarly to the New York voting district described in FIGS. 5 and 6. For example, if a Brazilian citizen wants to vote in a Brazilian election in England, then he or she can go to a Brazilian embassy, such as one in London in order to vote in the election. This invention allows Brazilians to vote for their Brazilian candidates whether it is for a local/general election while they are physically still in England. As stated above, the process of voting is equivalent to the electronic voting process of the NY district described in FIGS. 5 and 6, which utilizes the world private WAN to enable data flow.

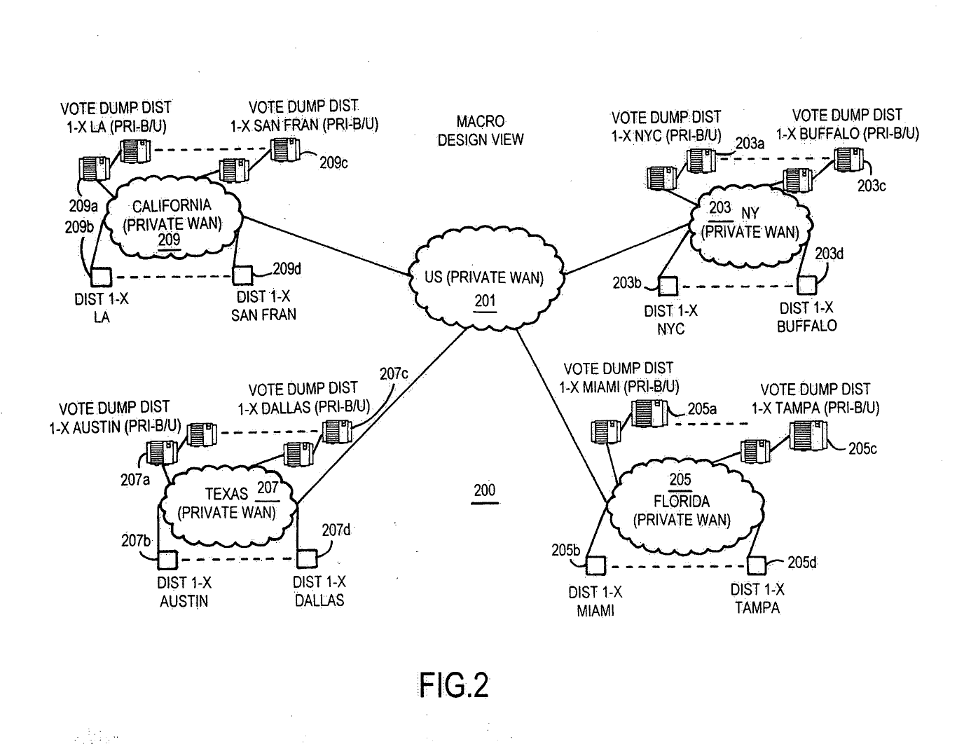

FIG. 2 is a block diagram of a national electronic voting system in accordance with the invention. The national electronic voting system 200 includes: a typical United States (U.S.) private worldwide wide area network (WAN) 201, a private New York WAN 203, a private Florida WAN 205, a private Texas WAN 207 and a private California WAN 209. The wide area network may also be a local access network (LAN), a wireless local network, a universal service bus (USB), an Ethernet link, a fiber-optic or the like. The US private WAN 201 is a series of interconnected private Intranets from each state's local district.

New York WAN 203 is connected to a New York City vote dump 203a, which is connected to a NYC voting district 203b. As stated above, the vote dump is a repository where all electronic ballots are stored, which include the following voter information: party affiliation, race, gender, election district, district assembly, congressional district, council district citizenship, civil court district and age of the voter.

Also, the New York WAN 203 is connected to the Buffalo Vote dump 203c that is connected to the Buffalo voting district 203d. Florida WAN 205 is connected to a Miami vote dump 205a, which is connected to a Miami voting district 205b. Also, the Florida WAN 205 is connected to the Tampa Vote dump 203c that is connected to the Tampa voting district 205d. Texas WAN 207 is connected to an Austin vote dump 207a, which is connected to an Austin voting district 207b. Also, the Texas WAN 207 is connected to the Dallas vote dump 207c that is connected to the Dallas voting district 207d. California WAN 209 is connected to a Los Angeles vote dump 209a, which is connected to a Los Angeles voting district 209b. Also, the California WAN 209 is connected to the San Francisco WAN vote dump 209a that is connected to the San Francisco voting district 209d.

For example, Florida's private WAN 205 is an intranet collection of Miami's voting districts 205c for Miami and 205d for Tampa. Also, the following cities may include local voting districts such as Fort Lauderdale, Orlando, Tampa and other Florida cities. These local voting districts operate in the same capacity as the voting districts in NY State and its cities. For example, if a New York state resident voted in Florida for his/her regional election, then the flow chart of FIG. 6 for the voter outside the district applies. The votes will be sent to the New York State Voting dump and their personal data will be uploaded on their local server.

FIG. 3 is a block diagram of local electronic voting system of a voting district in accordance with the invention. The local electronic voting system 300 includes: a WAN private network 301, a first voter booth 302, a distribution 1 primary server 303, a distribution 1 back-up server 305, a distribution 1 local server 307, a distribution 1 local back-up server 309, a first poll worker station 311, a second poll worker station 313, a voter district X distribution local private server 315, a voter district X local back up server 317, a voter distribution X voter booth 319, a distribution X primary server 321, a distribution X primary back-up server 323, a primary server vote dump 325 and a back-up server vote dump 327.

First poll worker station 311 includes a typical biometric device 311a and a poll worker 311b that operates the first poll worker station 311. A voter within a district 302a interacts with the biometric device 311a before she is able to interact with the typical voter booth 302, which is connected by a wire or wirelessly to the WAN 301.

Second poll worker station 313 includes a typical biometric device 313a and a poll worker 313b that operates the second poll worker station 313. A voter outside a district 319a interacts with the biometric device 313a before she is able to interact with the typical voter booth 319, which is connected by a wire or wirelessly to the WAN 301.

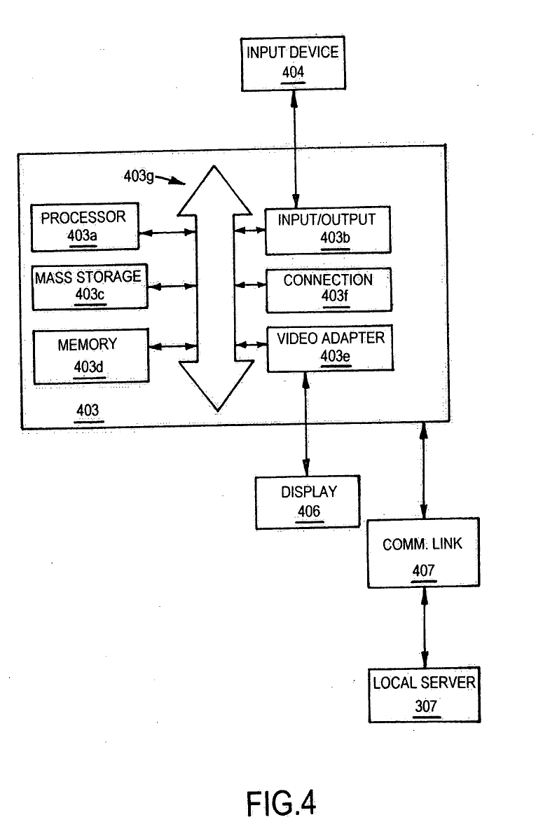

FIG. 4 is a schematic of a poll worker computer station with an electronic voting algorithm in accordance with the invention. The poll worker computer station 311 includes the poll worker 311a, biometric device 311a and a poll worker computer 403. Poll worker station device 403 includes the typical components associated with a conventional computer. The poll worker station device 403 includes: a processor 403a, an input/output (I/O) controller 403b, a mass storage 403c, a memory 403d, a video adapter 403e, a connection interface 403f and a system bus 403g that operatively, electrically or wirelessly, couples the aforementioned systems components to the processor 403a. Also, the system bus 403g, electrically or wirelessly, operatively couples typical computer system components to the processor 403a. The processor 403a may be referred to as a processing unit, a central processing unit (CPU), a plurality of processing units or a parallel processing unit. System bus 403g may be a typical bus associated with a conventional computer. Memory 403d includes a read only memory (ROM) and a random access memory (RAM). ROM includes a typical input/output system including basic routines, which assists in transferring information between components of the computer during start-up.

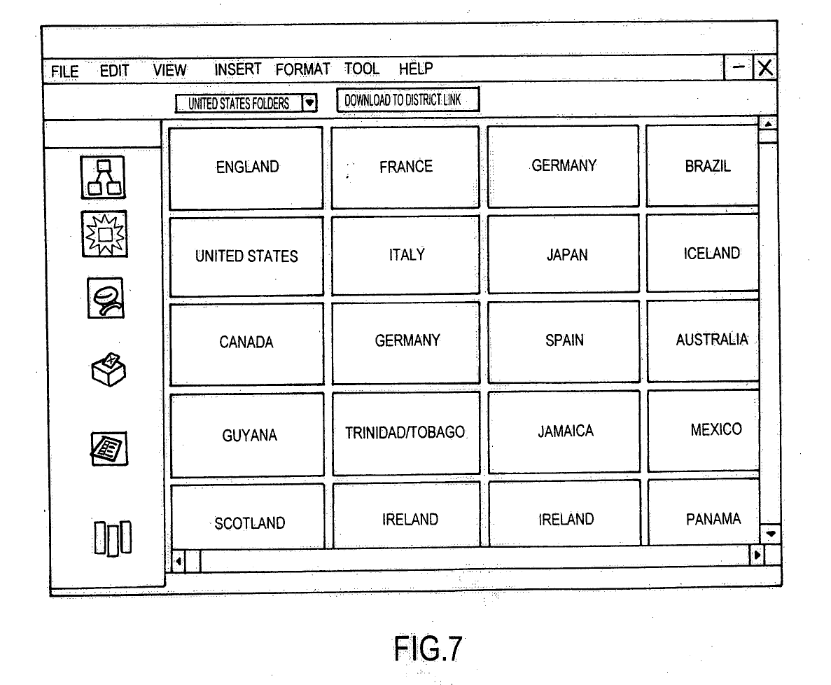

Input/output controller 403b is connected to the processor 403a by the bus 403g, where the input/output controller 403b acts as an interface that allows a user to enter commands and information into the computer through the electronic voting algorithm graphical user interface (GUI) shown in FIG. 7 and an input device 404, such as a keyboard and pointing devices. The typical pointing devices utilized are joysticks, mouse, game pads or the like. A display 406 is electrically or wirelessly connected to the system bus 403g by the video adapter 403e. Display 406 may be the typical computer monitor, plasma television, liquid crystal display (LCD) or any device capable of displaying characters and/or still images generated by a computer 403. Next to the video adapter 403e of the computer 403, is the connection interface 403f. The connection interface 403f may be referred to as a network interface, which is connected, as described above, by the communication link 407 to the distribution local server 307. Also, the computer 403 may include a network adapter or a modem, which enables the computer 403 to be connected to other computers.

Above the memory 403d is the mass storage 403c, which includes: 1. a hard disk drive component (not shown) for reading from and writing to a hard disk and a hard disk drive interface (not shown), 2. a magnetic disk drive (not shown) and a hard disk drive interface (not shown) and 3. an optical disk drive (not shown) for reading from or writing to a removable optical disk such as a CD-ROM or other optical media and an optical disk drive interface (not shown). The aforementioned drives and their associated computer readable media provide non-volatile storage of computer-readable instructions, data structures, program modules and other data for the computer 403. Also, the aforementioned drives include the technical effect of having an algorithm for processing an electronic vote such as software or equation of this invention, which will be described in the flow chart of FIG. 5.

The software has an electronic voting system shown as a screenshot of a graphical user interface (GUI) shown in FIG. 7. The electronic voting system graphical user interface is a specially programmed GUI that has some of the same functionality as a typical GUI, which as a software program designed to allow a computer user to interact easily with the computer 403. The electronic voting system GUI includes a screenshot that displays to the poll worker views when it is on a macro-level all of the countries linked to the voting network. The poll worker is able to press any button on the GUI of FIG. 7 by clicking or selecting it via the drop down, which allows the pole worker to access all serves such as the thee state, region, province etc. for that particular country. Then the poll worker can download all folders pertaining to the state, region, province etc. from that selected country and view them in the next link down from the Macro-Level shown in FIG. 1.

For example, a poll worker 311b in Brooklyn, N.Y. may want to capture only districts pertaining to the voting station. This Brooklyn pole worker 311b can select the US button, and clicks download to the district links button. It is important to note that the Download to district link button is not a standard button, because the US manages its voters by district, which is how this button is presented. However, if another country such as Canada manages its voters by provinces, then the download will reflect provinces.

FIG. 5 is a flow-chart of the operation of the local electronic voting system of FIG. 3 in accordance with the invention. At block 501, the first poll worker station computer 403 (FIG. 4) automatically downloads district data over a private Intranet network WAN 301 (FIG. 3) from the district 1 primary server 301 to the local server 307 to the poll worker station 311. The district data includes all the information associated with voters in the district, such as names, addresses, voting history, age, race, party affiliation etc. The poll worker station 311 on its display 406 requests the poll worker 311b to confirm his authorization to initiate the electronic voting system by using the biometric device 311a. Biometric device 311a is able to match voice, fingerprint, and face with local data displayed on the processor 403a of the poll worker computer station 403. After the poll worker 311b is given authorization to utilize the poll worker computer station 403, then the poll worker 311b is given access to the graphical user interface (GUI) of the worldwide electronic voting system of FIG. 7. At this GUI, the poll worker logs onto the voting network and clicks the Global Folders link. This Global Folders link enables the poll worker to view all countries linked to the voting network by clicking or selecting any country's button indicated. The country is selected by clicking or selecting via the drop-down menu, which allows the poll worker to access all servers by state, city, state, region, province etc for a particular country. Next, the poll worker 311b is able to download all folders pertaining to the particular city, state, region, province, etc from that selected country and view them in the next link down from the Global Folder link.

For example, a poll worker in Brooklyn, N.Y. or poll worker 311b may desire to capture only districts pertaining to the voting station. Poll worker 311b may select the US button as highlighted in FIG. 7, then clicks Download to District Link button. It is important to note that the Download to District button is not a standard button, because the US manages its voters by district, which is how the button is presented. However, in another example, another country such as Canada may manage its voters by provinces, so the download buttons will be reflected as provinces.

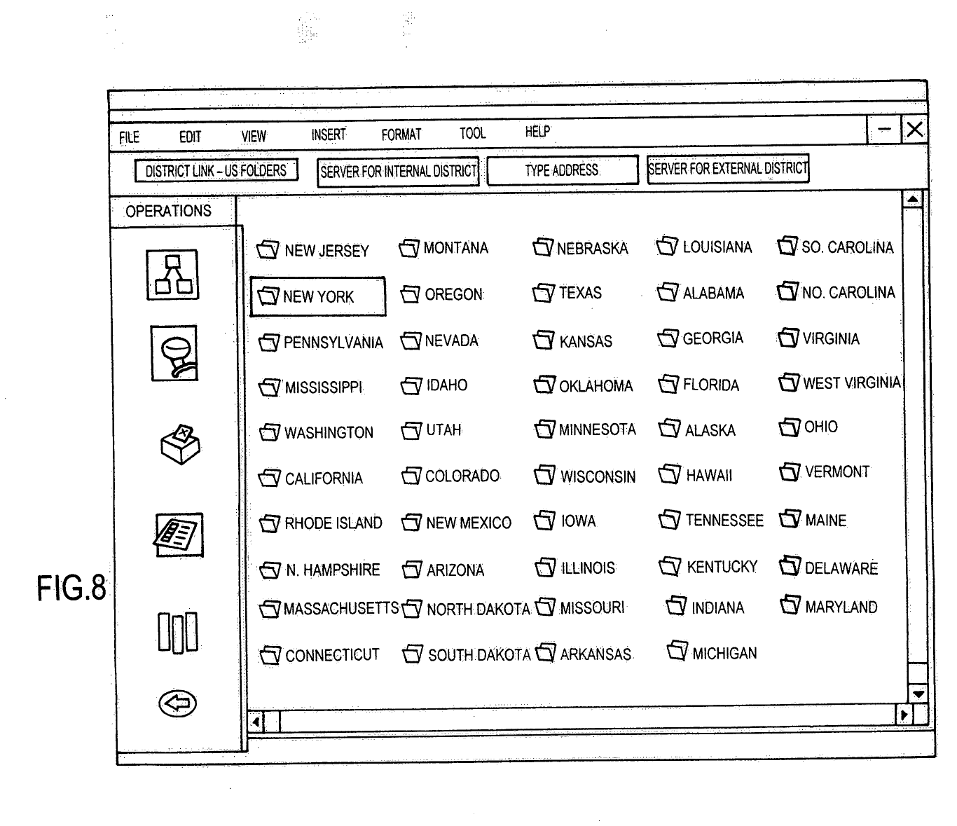

After the poll worker 311b selects the US download button, then the poll worker 311b selects the District link and views all state servers with in the US as shown in FIG. 8. For example, the Brooklyn poll worker or poll worker 311b can now find the desired district(s) for his/her poll station and download them to the local server such as local server 307 within the voting station. Poll worker 311b has the option of selecting the state drop-down menu or clicking the state directly. For voters external to the voting district, the poll worker 311b can either type the address provided by the external voter or directly clicking until their district folder is presented at the time of voting. Once obtained, then the poll worker 311b downloads their data to a separate local server designated to voters external to the voting station.

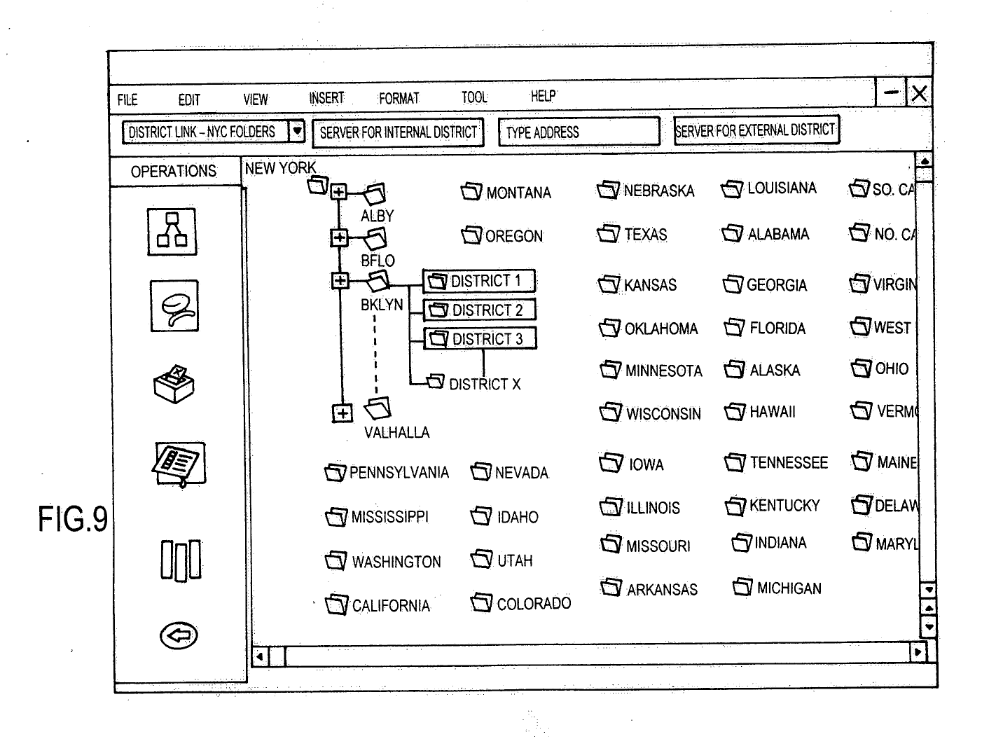

At FIG. 9, the poll worker 311b selects the New York state folder and views a drop-down folder of cities in New York State. The poll worker 311b selects the Brooklyn folder and finally selects all districts pertaining to his/her voting station that is downloaded into the local server, such as local server 307 for that voting district. The voter's data associated with the district will be downloaded with the following information: Citizenship, Ethnicity, Age, Sex and all other relevant voter information seen on a voter registration card. Likewise voters external to the voting district will have the same information downloaded. At no time will any personal information be transferred.

Returning to FIG. 5, at block 503 the voter 302a goes to the poll worker station 311 to provide his biometric information by the typical method such as scanning his face for facial structure information, taking fingerprint, voice recognition, eye-retinal or any method appropriate for the voting district or country utilizing the biometric device 311a.

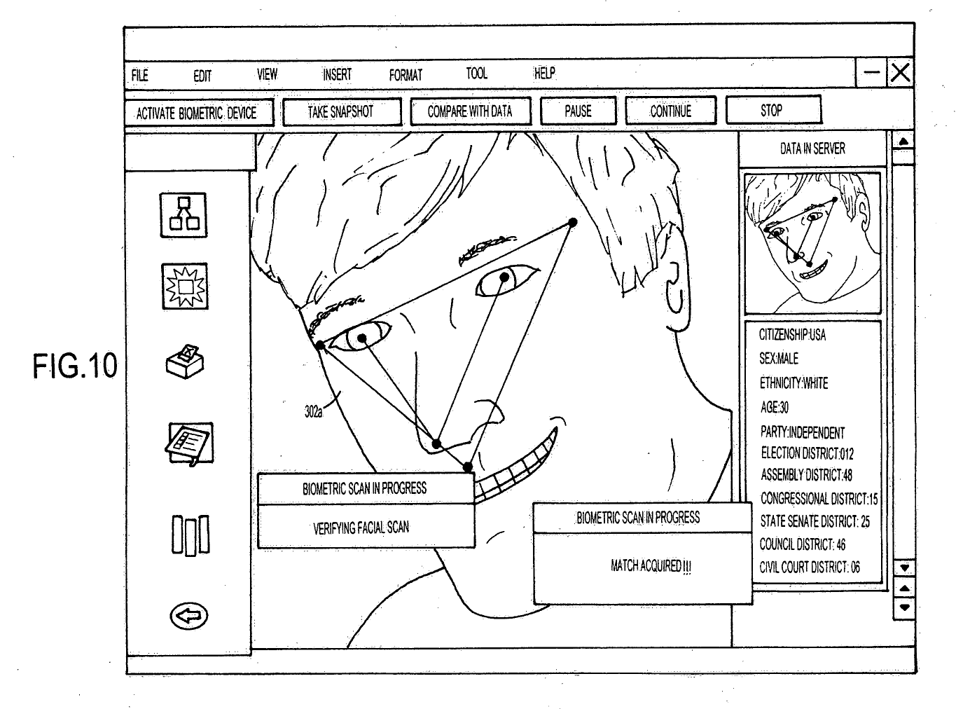

At block 505, there is a determination if a voter 302a or a plurality of voters is able to vote at the voting district 1 of FIG. 3. The poll worker station 311 received the biometric information from the local server 307. FIG. 10, shows a screenshot example of a graphical user interface (GUI) of the voter 302a. There is a biometric scan of the voter 302a's face and his voter information is shown on the right side of the screenshot. Poll worker 311b activates the biometric device 311a for both types of voters inside and outside of the district. This invention is not limited to only this biometric device any type of biometric device or method may be used in place of this current biometric device 311a. In an example, for the case of a facial biometrics, the voter 302a may step before the biometric device 311a and have his face scanned. Poll worker 311b will utilize the local server 307 to run through the districts information downloaded earlier until a biometric match of the face scan is made between the voter 302a and his/her data in the district database. If the voter 302a biometric information of the face scan is not equivalent to the biometric information for voter 302a, then the process goes to block 507 where new voter information is created and added to the relevant district database. However, if the biometric information face scan of the voter 302a recently provided to the biometric device 311a is equivalent to the biometric information face scan on the poll worker computer station 403a then the process continues to block 509.

Once a match is acquired or obtained, the poll worker 311b can verify on screen that the individual is the exact same person along with their appended data shown in FIG. 7. Poll worker 311b transfers the voter's data, on the poll worker computer 403 then updates the voter's data on both local servers.

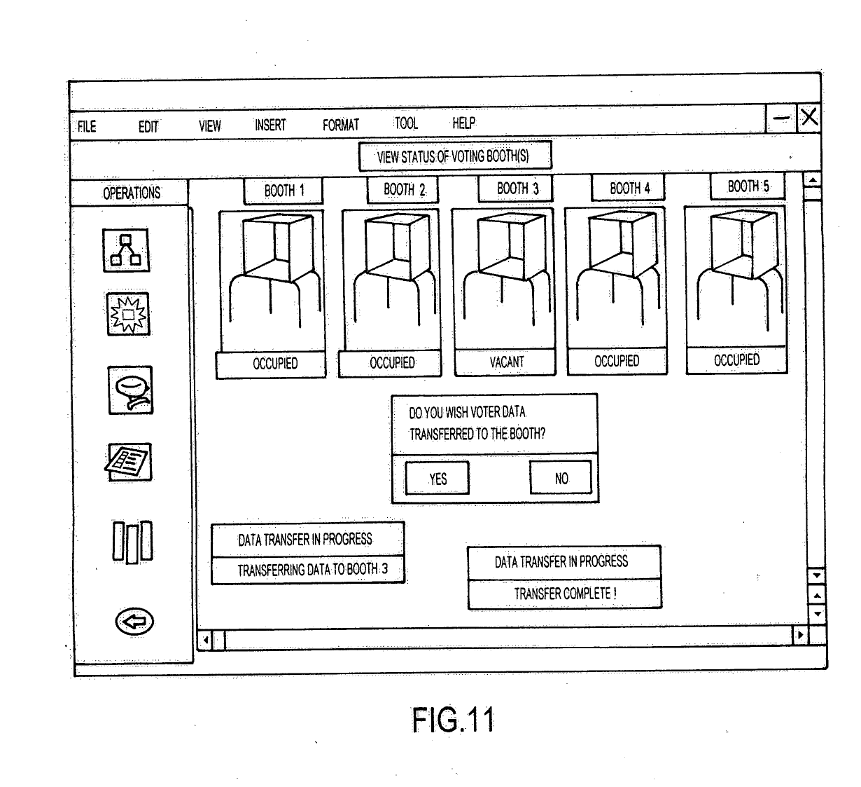

At block 509, the poll worker 311b informs the voter 302a that he can proceed to the electronic voting booth. FIG. 11 shows a screenshot of the plurality of voting booths at a polling station. Poll worker 311b transfers only the verified voter's 302a appended information to an available voting booth, voting booth station or voting machine. Poll worker 311b activates the voter booth link and observes which voting booth of the voting booth 1, voting booth 2, voting booth 3, voting booth 4 and voting booth 5. Once the poll worker 311b identifies a vacant booth, then the poll worker 311b transfers the appended data from the poll worker computer 403 by a wire connected to one of the voting booths or wirelessly to one of the voting booths. The vacant voting booth may be voting booth 3, then the poll worker 311b may instruct the voter 302a to approach the voting booth 3. At this time, one or more poll workers may also be used to direct voter 302a to the correct voting booth. The poll worker 311b chooses the exact voting booth voter 302a which will have his voter information, such as voter booth 3 instead of voter booth 1, 2, 4, or 5 that is occupied and doesn't have his information. Voting booth 1, voting booth 2, voting booth 3, voting booth 4 and voting booth 5 will all be electro-mechanical machines with a touch-screen or typical touch-screen voting machines. Even though voting booth 1, voting booth 2, voting booth 3, voting booth 4 and voting booth 5 was utilized here there may be more than 5, 10, 15, 100 or more voting booths utilized for this invention.

At block 511, the voter 302a is able to cast his vote for the local, regional or national election. This electronic vote is sent back to the poll worker station 311 where it is stored. Next, at block 513 a paper ballot based on the voter 302a electronic vote is outputted by the voter booth 302. The voting booth 3 will output a paper ballot n a secure location at the back of the voting booth 3.

At block 515, the poll worker station 311 utilizes a Ballot Management link stored on the poll worker computer station 403 to oversee the voting process, then tallies and compares electronic/paper ballots and stores them at the poll worker station 311 until the polling station closes. Poll worker 311b will view the following counts: total vote/ballot count and political party breakdown. Poll worker 311b will not view all voters' appended data associated with each vote in the voting booth. Each of the voting booths, such as voting booth 1, voting booth 2, voting booth 3, voting booth 4 and voting booth 5 as shown in FIG. 7 will electronically store a tally of votes/ballot counts (including associated appended data) and wirelessly update the local server through the WAN 301, such as local server 307 (for the district) continuously.

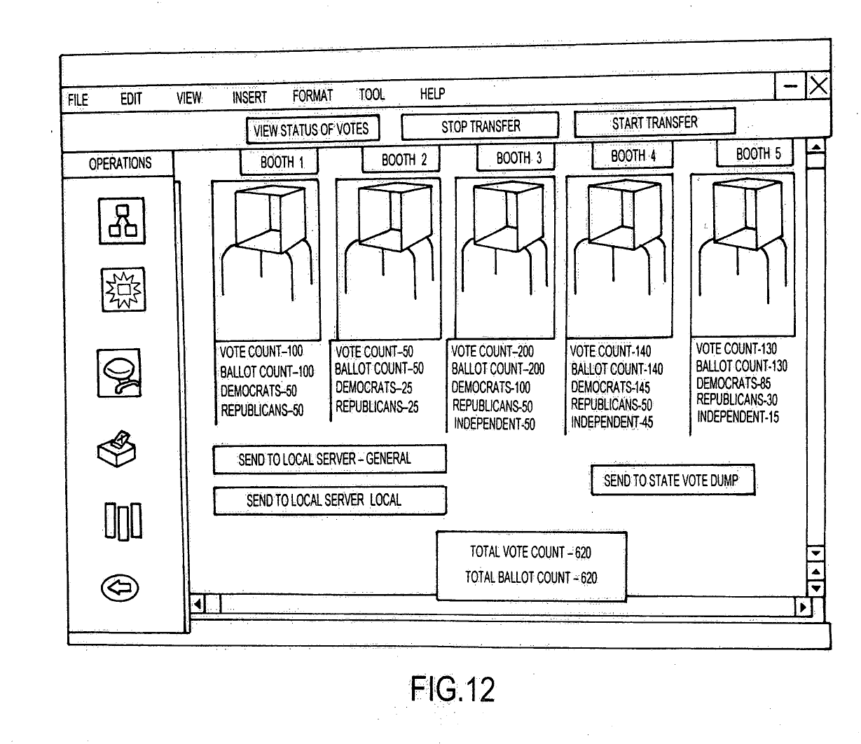

For example, for the voting booth 302 or voting booth 3 the tally may be 200 electronic/paper ballots and voting booth 4 or booth 319 (FIG. 3) has 140 electronic/paper ballots. As shown in FIG. 12, each of a plurality of voting booth includes: a vote count, a ballot count, Democrat count, Republicans count and Independent count. The total vote counts for all of the voting booths 1, 2, 3, 4 and 5 is 620. However, each of the voting booths may include more information than shown in this Figure. The poll worker 311b tallies both the electronic votes on the poll worker computer station 403 and the paper ballots to confirm and reconcile that they match, which she may send through the local distribution server 307 and the WAN 301 to the primary vote dump 327 depending on the poll closing time. Thus, if the voting booth 302 and voting booth 319 fails the poll worker 311 is able to calculate the number of electronic votes and paper ballots before the failure and store it on the poll worker computer 402. Poll worker 311b can designate where the votes are going on the local server 307 (general or local elections), view communication between the local server 307 and the either one of the voting booths 1, 2, 3, 4 or 5 and will only interrupt them if there is a problem with any or all of the voting booths 1, 2, 3, 4 or 5. Once interrupted the local server 307 will retain the most recent votes. Next, at block 517 there is a determination at the poll worker station 311 if the poll has been closed. For each different region of the city and countries, the polling station may have a required time to close, such as 7 pm in New York. If the time is not 7 pm then the polling station doesn't close and the process returns to block 515. However, if the time is 7 pm the polling station does close then at block 519 the poll worker 311b reviews or validates vote/ballot counts between the voting booths 1, 2, 3, 4 or 5 and local server 307 (for the district). Poll worker 311b both validates the electronic votes and the paper ballots, then the electronic and paper ballots are transmitted through the local distribution server, the WAN 301 to the primary vote dump 327. However, if there are irregularities at the State Vote Dump for any district, then the local server's 307 numbers will be used to verify any discrepancies. The votes can be stored on the local server 307 or the primary server 301 indefinitely until the next election cycle.

At block 521, there is an upload district/non district info to relevant database over the Intranet. At this point, as shown in FIG. 12 the poll worker 311b can view a screen shot of a graphical user interface (GUI) showing both general/local election results wirelessly sent by voting booth 1, voting booth 2, voting booth 3, voting booth 4 and voting booth 5 of FIG. 12. Poll worker 311b also can view the district folders, which contains renewal data from either voter type. This renewed data will be uploaded to each respected state server's district folders for each voter after the poll closes until the next cycle then the process ends.

FIG. 6 is a flow-chart of the operation of the national electronic voting system of FIG. 2 in accordance with the invention. This flow-chart is equivalent to the flow-chart of FIG. 5 from blocks 503 to 521, which is equivalent to blocks 603-621 so a description will not be disclosed herein. However, the first two blocks of FIG. 6 are different from FIG. 5 so they will be described. At block 601, an address of where the vote may be taken place is reported. For example, if a New York resident and US citizen is in England and he wants to vote in a regional election he may go to the United States Embassy in London. As shown in FIG. 1, the US Citizen goes to the London Embassy that has an England WAN connected to a vote dump US Embassy 103a and a US Vote Booth. While at the London Embassy the US citizen's information is transmitted to the World Private WAN 101 to a primary vote dump server 119a-119b where his address is reported. At block 602, there is a retrieval/download of the voter's district data over the Intranet into separate local databases. Next, the process continues for blocks 603-621 equivalent to blocks 503-521 as stated above.

This invention provides a system and method that enables a voter to securely and correctly vote in a local, regional or national election for his home country. The voter and the poll worker are able to be processed through a security system in order for the voter to vote, where the electronic votes are reconciled with a paper ballot to confirm that a vote has occurred. Next, the voter is able to securely vote in his home country even though he may be in a foreign city, state or country. Thus, this invention provides the user with a means to securely and correctly vote in his home city or country even though he may be abroad in another city, state or country.

What is claimed is:

1. An electronic voting system, the system comprising:
a state primary server configured to provide voting information of at least one voter through a private Intranet;
a poll worker computer station configured to receive the voting information of the at least one voter through the private Intranet;
a biometric device connected to the poll worker computer station, wherein the biometric device is configured to receive biometric information from a poll worker, wherein the biometric device validates that the poll worker can utilize the poll worker computer station;
the poll worker computer station configured to compare the voting information of the at least one voter with voter biometric information of at least one current voter to determine if the voter biometric information of the at least one current voter is equivalent to the voting information of the at least one voter; and
if the voting information of the at least one voter is equivalent to the voter biometric information of the at least one current voter then the at least one current voter can cast an electronic vote in at least one voting booth station of a plurality of voting booth stations, wherein the at least one voting booth station is configured to transmit the electronic vote to the poll worker computer station or a local server.

2. The electronic voting system of claim 1 wherein the biometric device is configured to analyze fingerprint, eye-retinal and facial structure information.

3. The electronic voting system of claim 1 wherein the poll worker computer station is configured to manage the plurality of voting booth stations.

4. The electronic voting of system of claim 3 wherein the poll worker computer station is configured to identify which one of the plurality of the voting booth stations the at least one current voter should utilize.

5. The electronic voting system of claim 1 wherein the at least one voting booth station can output a paper ballot of the electronic vote.

6. The electronic voting system of claim 1 wherein the poll worker computer station is configured to tally a plurality of votes from the plurality of voting booth stations.

7. The electronic system of claim 6 wherein the poll worker computer station is configured to tally the plurality of votes and transmit the votes to a vote dump.

8. The electronic voting system of claim 1 wherein the poll worker computer station is configured to extrapolate the votes at the poll worker computer station or at the local station server when a poll station is closed then transmit the votes to a state vote dump.

9. An electronic voting system, the system comprising:
a state primary server configured to provide voting information from a plurality of voters at least one voter through a private Intranet;
a poll worker computer station configured to receive the voting information of the plurality of voters through the private Intranet;
a biometric device connected to the poll worker computer stations wherein the biometric device is configured to receive biometric information from a poll worker, wherein the biometric device validates that the poll worker can utilize the poll worker computer station;
the poll worker computer station configured to compare the voting information of the plurality of voters with voter biometric information of a plurality of current voters to determine if the voter biometric information of the plurality of current voters is equivalent to the voting information of the plurality of voters; and
if the voting information of the plurality of voters is equivalent to the voter biometric information of the plurality of current voters then the plurality of current voters can cast an electronic vote in at least one voting booth station of a plurality of voting booth stations, wherein the at least one voting booth station is configured to transmit the electronic vote to the poll worker computer station or the local district server.

10. A method for utilizing an electronic voting system, the method comprising:
receiving voting information of at least one voter through a private Intranet;
receiving biometric information from a poll worker;
validating the biometric information that the poll worker can utilize the poll worker computer station;
comparing the voting information of the at least one voter with voter biometric information of at least one current voter;
determining if the voter biometric information of the at least one voter is equivalent to the voting information of the at least one current voter; and
casting an electronic vote if the voting information of the at least one voter is equivalent to the voter biometric information of the at least one current voter;
